(19) United States
(12) Patent Application Publication
(10) Pub. No.: US 2004/0246272 A1
(43) Pub. Date: Dec. 9, 2004

(54) Visual magnification apparatus and method

(76) Inventor: Artoun Ramian, Marbella (ES)

Correspondence Address: Law Office of William B. Ritchie, 43 Jackson Street, Concord, NH, 03301, US

(21) Appl. No.: 10/774,747

(22) Filed: Feb. 9, 2004

Related U.S. Application Data
(60) Provisional application No. 60/446,439, filed on Feb. 10, 2003.

(51) Int. Cl. G09G 5/00

(52) U.S. Cl. 345/660

(57) ABSTRACT

A visual display unit connected to a central processing unit such as exhibited with a personal computer. A sensor which measures the distance between the user and the visual display unit is provided. The purpose of the sensor enables the computer to determine the distance of the user in relation to the visual display unit, such that the size and content of information displayed upon the visual display unit can be automatically adjusted. As the user moves away from the visual display unit, the central processing unit causes the image shown on the visual display unit to enlarge any displayed information, thus counteracting the effects of perspective, which makes objects appear smaller the further away they are from the viewer. An alternative embodiment replaces the sensor with a web camera and a still image capture apparatus to measure the distance from the user to the visual display unit by utilizing at least two reference points on the user to make a “range finder” calculation.

This application claims benefit of priority under 35 U.S.C. §119(e) to U.S. Provisional Application Ser. No. 60/446,439, filed on Feb. 10, 2003.

### BACKGROUND OF INVENTION

1. Field of the Invention

The present invention generally relates to a document viewing system, with particular relevance to Visual Display Units (VDU).

2. Description of the Related Art

Numerous devices exist in the current art for magnifying visual information. In particular, the area of reading devices for the visually impaired provides many examples of devices which aid the user in reading books, magazines and the like. The present invention is concerned only with the visual representation of such information, as oppose to audio translation of textual information, i.e. machines which read aloud, using a synthesized voice.

Recent releases of MICROSOFT WINDOWS, such as WINDOWS 98, WINDOWS 2000 and the like, have all provided improvements for increasing the readability of text on VDUs, in relation to the visually impaired user. The improvements utilize high contrast color schemes, using fonts of increased size and providing a simple utility known as MAGNIFYING GLASS. This is a tool which emulates the magnifying capabilities of a spyglass, such that moving the cursor around the screen moves a virtual spyglass, effectively magnifying the portion of the screen directly below the cursor. The virtual spyglass merely serves to stimulate developer's thoughts in the field of improving readability of displayed materials and is not intended to meet the characteristics described herein. Specifically, the virtual spyglass lacks awareness of the present user's individual needs. The program does not automatically determine what magnification factor to use.

Other magnification devices, such as overhead projectors, binoculars, and spectacles, lack an automatic adjustment for the user; are made for a specific user; or are too cumbersome to be adapted for use by a single person.

The norm for present day word-processing, and other data processing tools is to provide increase the font size used to represent a document being viewed by the user. An example of this method can bee seen in MICROSOFT WORD, where the user selects a magnification factor expressed as a percentage, with default settings ranging from 10% to 500%. As with previously described devices, this method of magnification lacks the ability to automatically adjust the font size to the user's needs, which vary in real time, as the user's distance from the screen increases and decreases.

Therefore a method of automatically controlling the magnification factor of material displayed on a VDU, by means of sensing the user's distance from the VDU is not found in the prior art.

### SUMMARY OF THE PRESENT INVENTION

It is an aspect of the present invention to provide a user with a dynamically sized image, which appears to be a constant size, regardless of the user's distance from the VDU displaying the dynamically sized image. The user is able to control the point upon a viewed image at which magnification occurs. The user may issue commands by hand or body movements. Also, each user of a particular VDU equipped with the invention is able to store the user's requirements as rules which direct the magnification behavior of the invention.

The invention provides facilities for effectively canceling the effects of perspective, which causes objects that are far away to appear smaller as the user moves away from them. In particular, a VDU when connected to a personal computer will dynamically resize the information such that it appears to be the same size on the screen regardless of whether the user moves closer or farther away from the VDU.

When a user moves away from his/her VDU, the image on the screen, typically made up of textual information, will remain legible. This is particularly useful for users having common vision impairments which are typically corrected by glasses or contact lenses.

The invention provides a preferred text size to maintain the size of an image, despite the fact that the user may move closer to a further away from the image.

If a user wore a pair of clear non-prescription glasses having a measuring scale etched on the lenses, such that the user could describe how tall an object appeared to be when viewed through the lenses, then the user would observe that an image displayed on a VDU related to the present invention stayed at a constant size. The image would not grow progressive smaller, as would naturally occur when the user moved away from the image.

To further clarify the manner in which the invention works; if the user described a text character on the VDU as being 10 millimeters high, when viewed from a distance of 1 meter, then, even when the user moved away to a distance of 2 meters, the text character would still appear to be 10 millimeters high. This behavior is facilitated by the fact that the invention dynamically resizes the text character, and indeed, all information displayed on the VDU, to maintain an apparently constant size.

Other aspects, features and advantages of the present invention will become obvious from the following detailed description that is given for one embodiment of the present invention while referring to the accompanying drawings.

### BRIEF DESCRIPTION OF THE DRAWINGS

FIG. 1 is an illustration of visual magnification apparatus in accordance with the invention.

FIG. 2 is a graph showing the time plot of a simple gesture command in accordance with the invention.

FIG. 3 is a graph showing how the image remains substantially constant over distance as well.

### DETAILED DESCRIPTION OF THE INVENTION

The invention is an information processing apparatus and method having at least one VDU, typically utilizing a central processor as provided within a personal computer. A sensor which measures the distance between the user and the VDU is also provided. The purpose of the sensor enables the computer to determine the distance of the user in relation to the VDU, such that the size and content of information displayed upon the VDU can be automatically adjusted.

The software logic of the preferred embodiment behaves in such a way that as the user moves away from the VDU, the CPU causes the image rendered upon the VDU to enlarge any displayed information, thus counteracting the effects of perspective, which makes objects appear smaller the further away they are from the viewer.

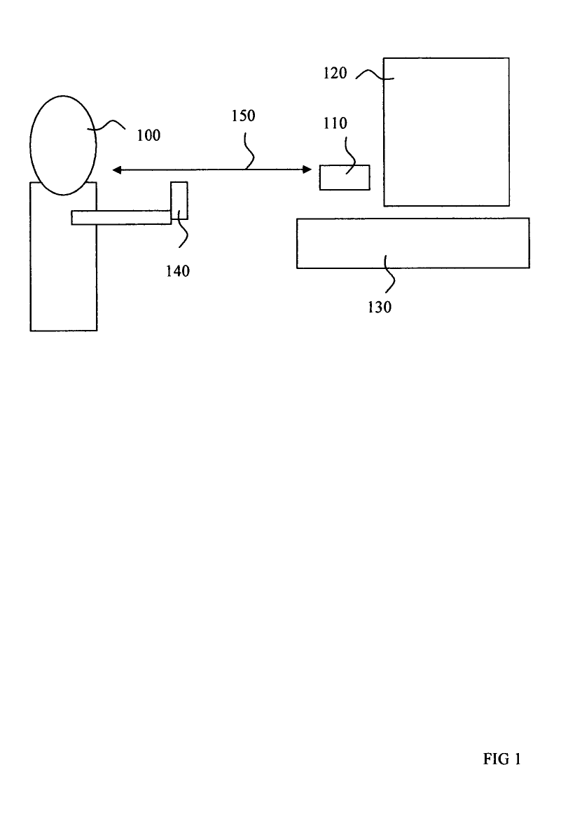

FIG. 1 is an illustrative overview of the invention depicting example positions for user 100 and sensor 110.

Sensor 110 is a statically positioned measuring device which emits a signal, that when returned, enables sensor 110 to discern the distance between itself and any object at which it is pointed. Sensor 110 is known in the art in several forms, commonly appearing as ultrasonic tape measures or similar such instruments.

Sensor 110 is connected to CPU 130, such that the distance between user 100 and VDU 120 is reported to CPU 130, which can then act upon the distance reported by sensor 110. Sensor 110 could be connected to the CPU 130 via an RS-232 connection or a parallel connection or by using a USB port, all of which are well known in the art.

Sensor 110 constantly records the distance between itself and user 100. Last recorded distance is defined as the most recent sample taken by sensor 100 to find the distance between itself and user 100.

Refresh rate is defined as the number of times per second that CPU 130 periodically queries sensor 100 to retrieve the last recorded distance.

Devices suitable for use as sensor 100 typically capture distance information many hundreds of times per second. CPU 130 will typically only use a refresh rate of approximately 25 times per second. The refresh rate can be modified in alternate embodiments to provide smoother transitions in size as the invention alters the magnification factor used to increase the size of the image displayed on VDU 120.

Higher refresh rates will obviously demand a higher powered CPU 130 than lower refresh rates, due to the amount of computing power required to resize and re-render any image displayed on VDU 120.

Furthermore, CPU 130 may take several the last recorded distances and compare them, looking for a sequence of near identical distances, which would indicate that the user has settled in a particular position and is not moving backwards and forwards, as may occur if user 100 were shuffling in their chair. This would minimize any risk of inducing motion sickness in user 100, which typically occurs if an image on VDU 120 alters in an unpredictable manner, or even appears to move up and down slightly, a problem which affects some players of video games.

User 100 can also use hand 140 to construct gestures which are then sensed by sensor 110.

In typical use, sensor 110 emits beam 150 which is reflected off of the head or body of user 100, thus sensing the distance between user 100 and sensor 110. As sensor 110 repeatedly emits beam 150 and user 100 moves away from sensor 110, sensor 110 will see a smooth increase in the distance between itself and user 100.

Any sudden change in the distance sensed between sensor 110 and user 1100 would mean that user 100 either moved out of the field of view of sensor 100, or that a larger than normal distance was reported, or that user 100 had interrupted beam 150 by placing a hand close to sensor 110.

Any of the sudden change in distance is interpreted by the invention to mean that user 100 has placed hand 140 in beam 150, causing sensor 110 to see a sudden decrease in distance between itself and user 100.

This forms the basis of a gesture recognition system found in the invention.

Command is defined as a collection of at least one gesture, where a gesture is detected by sensor 110 as a sudden change in distance, followed by a smooth increase or decrease in distance, followed by a final sudden change in distance.

To illustrate; user 100 is positioned at a distance of 1 meter from sensor 110 and moves gradually back to a distance of 1.2 meters. Sensor 110 reports the smooth increase in distance and CPU 130 interprets this smooth motion as user 100 moving away. However, if user 100 sits at the same distance of 1 meter, then raises hand 140 into beam 150 at a distance approximately 0.5 meters from sensor 110, sensor 110 will report a sudden change of distance to CPU 130. CPU 130 will then interpret this as the beginning of a gesture. User 100 then moves hand 140 away from sensor 110, thus the sensed distance increases. CPU 130 then awaits a sudden change of distance again, which signals the end of the gesture. As noted above, the sudden change of distance, followed by smooth motion, finally accompanied by another sudden change of distance forms the command.

The illustrated command can then be used by the invention to either alter the magnification factor preferred by user 100, or to scroll or otherwise manipulate the image displayed on VDU 120.

Commands found within the preferred embodiment scroll the image displayed on VDU 120 up or down, depending on if the command is based on a smooth increase or decrease in motion. A smooth increase in distance can be interpreted to scroll the image up and a smooth decrease in distance can be interpreted to scroll the image down. Other commands can be constructed by compounding further sequences of gestures or other commands, such that a multitude of gestures can be used to control all aspects of the image displayed by VDU 120. The other aspects of the image can include brightness, contrast, magnification factor, resolution, color intensity, color scheme or other attributes of VDU 120 and the displayed image.

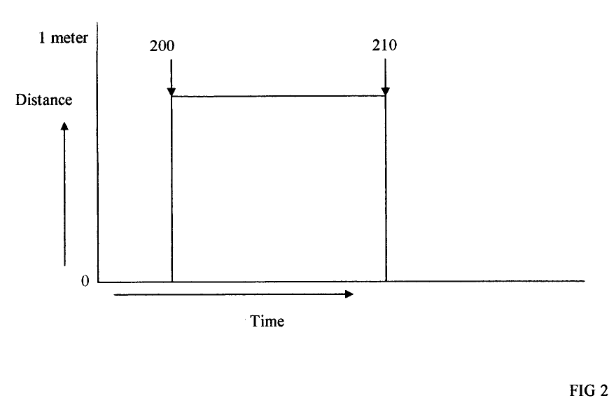

Referring to FIG. 2, a time plot of a simple gesture is shown. Time is plotted along the X axis and distance is plotted over the Y axis. For simplicity, the graph shows a distance of zero for a period of time before point 200, where the distance then moves from zero to 0.5 meters substantially instantaneously, which is maintained until point 210 where the distance sensed returns to zero once more. Therefore, the plot illustrated in FIG. 2 indicates that an object was measured at 0.5 meters from sensor 110 (see FIG. 1) for a period of time before returning to a point substantially closer to sensor 110.

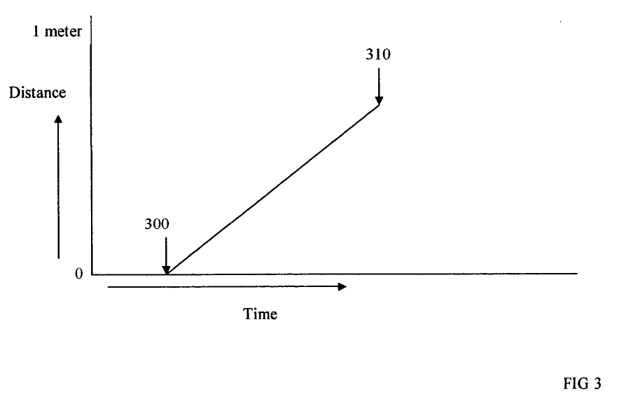

As shown in FIG. 3, again with time on the X axis and distance on the Y axis, the distance is smoothly increased from zero to 0.5 meters over a period of time. When such a behavior is detected, the invention interprets this as user 100 is moving away from sensor 110. The inverse behavior, i.e. user 100 moving closer to sensor 110 would cause the plot to have the opposite slope.

An alternate embodiment of the present invention could be formed by utilizing a web camera and a still image capture system (SICS).

The web camera enables the SICS to capture a scene including user 100. The SICS then finds two identifiable points on user 100, for example, the corners of the shoulders, the eyes of user 100, or two colored disks attached to user 100.

The distance between the two identifiable points means that an approximate distance, between user 100 and the web camera, can be calculated. Due to the effects of perspective, from the point of view of the web camera, as user 100 moves away from the web camera, the two identifiable points will appear to move closer together.

Once the approximate distance has been calculated, the invention will then be able to apply an appropriate magnification factor on VDU 110.

The two colored disks serve the same purpose as small infra-red reflecting spheres. These spheres, which are attached to actors, track movement in motion capture systems. This method is well known in the art.

The two colored disks are a distinct color which the SICS is easily able to identify in any captured scene having user 100. Therefore, disks can be used to provide two identifiable points.

The two identifiable points are required to be located in the image of the scene captured by the SICS, therefore, SICS searches the image data in order to find the approximate centre of the two colored disks.

Though the alternate embodiment eliminates the requirement for sensor 110, an additional computational load is placed on CPU 130. The additional computational load is due to additional processing cycles required to capture a still image, analyze the still image to locate the two identifiable points, and finally calculate the distance between the two identifiable points.

The illustrated embodiments of the invention are intended to be illustrative only, recognizing that persons having ordinary skill in the art may construct different forms of the invention that fully fall within the scope of the subject matter appearing in the following claims.

What is claimed is:

1. A visual display unit having an image that is to be viewed by a user, said visual display unit comprising:
a central processing unit connected to said visual display unit; and
sensor means of measuring the distance between the user and said visual display unit; and
dynamically sizing means, controlled by said central processing unit, for changing the size of the image so that the image appears to the user as being of constant size when the user moves closer or further from said visual display unit as provided by said sensor means; and
memory storage means for storing the information about the user's eyesight and corresponding magnification of the image previously used.

2. The visual display unit of claim 1 wherein said sensor is an ultrasonic tape measure.

3. The visual display unit of claim 1 wherein said central processing unit has a refresh rate of less than or equal to 25 times per second to provide smoother transition in the size of the image as said sizing means alters the magnification of the image.

4. The visual display unit of claim 1 further comprising user activation means for responding to sudden changes in distance of the user from said visual display unit as measured by said sensor means.

5. The visual display unit of claim 4 wherein said user activation means when activated causes the image to scroll.

6. The visual display unit of claim 4 wherein said user activation means when activated causes the image to change in magnification.

7. A visual display unit having an image that is to be viewed by a user, said visual display unit comprising:
a central processing unit connected to visual display unit; and
a web camera; and
still image capture means to capture a scene provided by said web camera,
wherein the scene includes the user have at least identifiable points on the user such that said central processing unit calculates the distance between said visual display unit and the user; and
dynamically sizing means, controlled by said central processing unit, for changing the size of the image so that the image appears to the user as being of constant size when the user moves closer or further away from said visual display unit.

8. The visual display unit of claim 7 further comprising memory storage means for storing the information about the user's eyesight and corresponding magnification of the image previously used.

9. The visual display unit of claim 7 further comprising at least two colored disks which are associated with the user and which serve as said at least two identifiable points on the user such that the distance to the user is calculated.

10. The visual display unit of claim 7 wherein said central processing unit has a refresh rate of less than or equal to 25 times per second to provide smoother transition in the size of the image as said sizing means alters the magnification of the image.

11. The visual display unit of claim 7 further comprising user activation means for responding to sudden changes in the measured distance of the user from said visual display unit.

12. The visual display unit of claim 11 wherein said user activation means when activated causes the image to scroll.

13. The visual display unit of claim 11 wherein said user activation means when activated causes the image to change in magnification.
